(19) United States
(12) Patent Application Publication
(10) Pub. No.: US 2026/0307368 A1
(43) Pub. Date: Oct. 8, 2026

(54) RECYCLABLE PACKAGING FILM AND PACKAGE

(71) Applicant: AMCOR FLEXIBLES NORTH AMERICA, INC., Neenah, WI (US)

(72) Inventors: Melissa K. COOLICH, Hortonville, WI (US); Ross K. GRUETZMACHER, Neenah, WI (US); Scott D. HOWELLS, Oshkosh, WI (US); Lee M. SCHNEIDER, Neenah, WI (US); Rebecca J. SHOTWELL, Neenah, WI (US)

(21) Appl. No.: 19/481,161

(22) PCT Filed: May 15, 2023
(86) PCT No.: PCT/US2023/022235

§ 371 Date: Nov. 3, 2025

(51) Int. Cl. B32B 27/08; B32B 27/20; B32B 27/30; B32B 27/32; B65D 65/40

(52) U.S. Cl. CPC B32B 27/08; B32B 27/20; B32B 27/306; B32B 27/32; B65D 65/40; B32B 2250/24; B32B 2255/10; B32B 2307/72; B32B 2307/7244; B32B 2307/7376; B65D 2565/386

(57) ABSTRACT

A recyclable packaging film includes a multilayer polyethylene-based film, a release over lacquer layer, an ink layer, and a patterned sealable material layer. The release over lacquer layer includes a first exterior surface of the recyclable packaging film, The ink layer that may be positioned between a first outer surface of the multilayer polyethylene-based film and the release over lacquer layer. The patterned sealable material layer may be positioned on a second outer surface of the multilayer polyethylene-based film that includes a second exterior surface of the recyclable packaging film. The multilayer polyethylene-based film includes a polyethylene-based polymer content that includes a high density polyethylene and an additional polyethylene in a range of from 90% to 100%, by weight of the multilayer polyethylene-based film.

### TECHNICAL FIELD

This disclosure is related to a recyclable packaging film and a package formed from the recyclable packaging film. The package may contain food items, such as confections, or non-food items.

### BACKGROUND

Confections, including candy, chocolate, ice cream, or sweet ingredients, for example, are often packaged in flexible film packages that are often referred to as flow wrap packages. Flexible films typically include a thickness of less than about 254 microns (10 mil) and are capable of being flexed or bent, especially repeatedly, such that they are pliant and yieldable in response to externally applied forces, for example, accommodating external forces to conform to the shape of objects, particularly, food products brought into contact with them without losing their integrity. The flexible film flow wrap packages include a cold seal or pressure sensitive adhesive that is designed to adhere to itself with relatively low pressure and without heat. The cold seal adhesive is applied in a pattern on the film and can form a sealed package when adhered to itself. Some packages may alternately include a heat seal.

The films often incorporate a lamination of at least two films. One or a combination of laminated films may provide barrier properties, for example to prevent the ingress of oxygen or moisture into the package. Another film of the laminated film is often reverse-printed with graphics related to product branding, or usage or nutrition information related to the product contained in the package. The laminated film includes characteristics for efficient conversion into a package (e.g., stiffness, coefficient of friction, etc.). Polypropylene-based films are often used to package confections because polypropylene provides appropriate barrier and converting criteria allowing the film to be converted into a flow wrap package or a package suitable for confections.

Another way to provide barrier is by including metallization in the film structure. Metallization (e.g., aluminum vapor deposition) introduces additional processing steps and cost into the film manufacture.

Global demand for plastic waste reduction and sustainable packaging solutions is on the rise. Metallized film structures cannot be recycled in some polymer-based recycling streams. Further, recycling processes for some polymers do not exist in some countries; for example, the United States does not currently have a recycling stream for flexible polypropylene-based films.

### SUMMARY

This disclosure relates to packaging film that can be used to package food or non-food items in a flow wrap package format that includes a patterned sealing material. The packaging film is polyethylene-based and includes high density polyethylene. The packaging film may be recyclable in a polyethylene-based recycling stream. The packaging film is conversion friendly.

In a first embodiment, a recyclable packaging film may comprise a first exterior layer, a second exterior layer, a release over lacquer layer, an ink layer, and a patterned sealable material layer. The first exterior layer may comprise a first outer surface of a multilayer polyethylene-based film. The second exterior layer may comprise a second outer surface of the multilayer polyethylene-based film. The release over lacquer layer may comprise the first exterior surface of the recyclable packaging film. The ink layer may be positioned between the first outer surface of the multilayer polyethylene-based film and the release over lacquer layer. The patterned sealable material layer may be positioned on the second outer surface of the multilayer polyethylene-based film further comprising the second exterior surface of the recyclable packaging film. The multilayer polyethylene-based film may comprise a polyethylene-based polymer content comprising a high density polyethylene and an additional polyethylene in a range of from 90% to 100%, by weight of the multilayer polyethylene-based film.

In a second embodiment, a packaging film may comprise a multilayer polyethylene-based film having a first outer surface and a second outer surface, a release over lacquer layer adjacent to the first outer surface, an ink layer that may be positioned between the first outer surface and the release over lacquer layer; and a patterned sealable material layer may be positioned on the second outer surface. The multilayer polyethylene-based film may comprise a high density polyethylene in a range of from 50% to 100%, by weight of the multilayer polyethylene-based film, a low density polyethylene and/or a linear low density polyethylene in a range of from 0% to 50%, by weight of the multilayer polyethylene-based film, and a medium density polyethylene in a range of from 0% to 40%, by weight of the multilayer polyethylene-based film.

Other features that may be used individually or in combination with respect to any embodiment are as follows:

The high density polyethylene may have a density in a range of from 0.935 g/cm³ to 0.970 g/cm³.

The multilayer polyethylene-based film may comprise a free shrink value of less than 20% in both a machine direction and a transverse direction when tested according to ASTM D2732 using a bath temperature of 90° C.

The multilayer polyethylene-based film may comprise a free shrink value of 10% or less in both a machine direction and a transverse direction when tested according to ASTM D2732 using a bath temperature of 90° C.

The recyclable packaging film or the packaging film may comprise a barrier layer that may comprise ethylene vinyl alcohol copolymer (EVOH), polyvinyl alcohol copolymer (PVOH), butenediol vinyl alcohol copolymer (BVOH), crosslinked acrylates, partially neutralized acrylic polymers, copolymers of monobasic ethylenically unsaturated carboxylic acids with ethylene, water dispersible acidic moieties, or combinations thereof.

The barrier layer may be positioned between the first exterior surface of the recyclable packaging film and the second exterior surface of the recyclable packaging film, on the first exterior surface of the recyclable packaging film, or combinations thereof.

The barrier layer may be positioned between the first outer surface of the multilayer polyethylene-based film and the second outer surface of the multilayer polyethylene-based film, on the first outer surface of the multilayer polyethylene-based film, or combinations thereof.

The multilayer polyethylene-based film may comprise a thickness in a range of from 0.6 mil to 3.0 mil.

The multilayer polyethylene-based film may comprise a normalized moisture vapor transmission rate lower than 2.0 g/m²/day per mil according to ASTM F1249-06.

The recyclable packaging film or the packaging film may further comprise a density of less than 1.0 g/cm³.

The patterned sealable material layer may comprise a cold seal material.

The recyclable packaging film or the packaging film may further comprise a pigment.

Other features that may be used individually or in combination with respect to the first embodiment are as follows:

The multilayer polyethylene-based film may comprise the high density polyethylene in a range of from 50% to 100%, by weight of the multilayer polyethylene-based film.

The additional polyethylene may comprise linear low density polyethylene (LLDPE), a low density polyethylene (LDPE), a medium density polyethylene (MDPE), or a combination thereof.

The first outer layer may comprise the high density polyethylene in a range of from 20% to 100%, by weight of the first outer layer.

The second outer layer may comprise the high density polyethylene in a range of from 20% to 100%, by weight of the second outer layer.

Another feature that may be used individually or in combination with respect to the second embodiment includes that the packaging film may further comprise a polyethylene-based polymer content in a range of from 90% to 100%, by weight of the packaging film.

### BRIEF DESCRIPTION OF THE DRAWINGS

The disclosure may be more completely understood in consideration of the following detailed description of various embodiments of the disclosure in connection with the accompanying drawings, in which:

FIG. 1 illustrates a schematic cross-sectional view of an embodiment of a multilayer polyethylene-based film;

FIG. 2 illustrates a schematic cross-sectional view of an embodiment of a multilayer polyethylene-based film;

FIG. 3 illustrates a schematic cross-sectional view of an embodiment of a recyclable packaging film;

FIG. 4 illustrates a schematic cross-sectional view of an embodiment of a recyclable packaging film;

FIG. 5 illustrates a plan view of an interior surface of an embodiment of a recyclable packaging film,

FIG. 6 illustrates a perspective view of an embodiment of a sealed package including a recyclable packaging film; and

FIG. 7 illustrates a perspective view of an embodiment of the sealed package shown in FIG. 6 that contains a product.

The drawings show some but not all embodiments. The elements depicted in the drawings are illustrative and not necessarily to scale, and the same (or similar) reference numbers denote the same (or similar) features throughout the drawings.

### DETAILED DESCRIPTION

Described herein are recyclable packaging films and packaging films that may be used for flow wrap package formats. Flow wrap package formats may include flow wrap packages that are sealed with patterned sealable material that may include cold seal or heat seal coatings or adhesive. Food or non-food products may be packaged in the flow wrap packages. Non-limiting food product examples include confections, such as candy or chocolate bars. The product may be sensitive to oxygen and/or moisture such that the film prevents the ingress of oxygen and/or moisture. The recyclable packaging film and the packaging film include a multilayer polyethylene-based film that includes a high density polyethylene, a release over lacquer, an ink, and a patterned sealable material.

The recyclable packaging film described herein may be suitable for recycling. As used in this application, the term “suitable for recycling” is meant to indicate that the recyclable packaging film can be converted into a new, useful item by means of reprocessing in a recycle stream. Reprocessing may entail washing, separating, melting, and forming, among many other steps. Typically, when polymeric items are recycled by reprocessing, the material is mechanically chopped into small pieces (e.g., granulated, flaked, etc.), melted, mixed, and reformed into the new product. If multiple incompatible materials are present in the items to be recycled, interactions occur during reprocessing that can cause gels, brittle material, poor appearance, and generally unusable or poor quality products. Using the term “recyclable” indicates that these drawbacks generally are not present.

### Multilayer Polyethylene-Based Film

The recyclable packaging film includes a multilayer polyethylene-based film. The multilayer polyethylene-based film includes a polyethylene-based polymer content that includes a high density polyethylene and an additional polyethylene in a range of from 90% to 100%, by weight of the multilayer polyethylene-based film. The multilayer polyethylene-based film includes a first outer layer, a second outer layer, and may include a first inner layer. The first outer layer and the second outer layer include a first outer surface and a second outer surface, respectively, of the multilayer polyethylene-based film.

The term “layer”, as used herein, refers to a building block of a film that is a structure of a single material type, a homogeneous blend of materials, or a dispersion blend of materials. A layer may be a single polymer, a blend of materials within a single polymer type or a blend of various polymers, may contain metallic materials, and may have additives. Layers may be continuous with the film (i.e., coextensive with the film) or may be discontinuous or patterned. A layer has an insignificant thickness (z direction) as compared to the length and width (x-y direction), and therefore is defined to have two major surfaces, the area of which are defined by the length and width of the layer. An exterior layer is one that is connected to another layer at only one of the major layer surfaces. In other words, one major surface of an exterior layer is exposed.

As used herein, the terms “exterior layer”, “exterior film”, “surface layer”, or “surface film”, are used to describe a film or layer that does not have another layer on at least one of its major surfaces and is located on one of the major surfaces of the film in which it is comprised. For example, a surface layer is on an exterior of the multilayer structure.

Similarly, the term “film” refers to a web built of layers and/or films, all of which are directly adjacent to and connected to each other. A film can be described as having a thickness that is insignificant as compared to the length and width of the film. Films are generally regarded as having two major surfaces, opposite each other, expanding in the length and width directions.

The term “multilayer”, as used herein, refers to a single substrate structure (e.g., film, ply, etc.), which may have a plurality of layers, generally in the form of a sheet or web that can be made from a polymeric material or a non-polymeric material bonded together by any conventional means known in the art, (i.e., coextrusion, lamination, coating, or a combination thereof).

Multilayer structures include as many layers as desired and, preferably, at least two layers. In multilayer structures that include at least three layers, the structure includes an interior layer. As used throughout this application, the terms “interior layer” or “inner layer” refer to a layer that is positioned between two other layers, is connected to another layer at both major surfaces, and is not located on the surface of the film in which it is comprised. An interior film or layer is adjacent to another film or layer on both surfaces. In other words, an interior layer is between two other layers. A layer may have sub-layers.

As used herein, the term “adjacent” means that the items, such as layers of a film, are near each other, with or without intervening material, such as adhesive. As used herein, the term “directly adjacent” or “in direct contact with” means that the items are in contact with each other, without intervening material

The multilayer polyethylene-based film may be produced by coextrusion with all the layers simultaneously combined, for example by blown or cast film processes. Alternatively, the layers of the multilayer film may be combined by other known processes including, but not limited to, extrusion coating, extrusion lamination, and adhesive lamination.

The multilayer polyethylene-based films of this disclosure may be machine direction oriented such that the multilayer polyethylene-based films may only be oriented in a machine direction and may not be oriented to any significant amount in a transverse direction. Each of the layers of the multilayer polyethylene-based film should be combined prior to orientation of the multilayer film. In other words, each of the layers should be subjected to the same orientation process, at the same time. Orientation may be the result of monoaxially oriented (machine direction) stretching of the film, increasing the machine direction dimension, and subsequently decreasing the thickness of the material. The film is subjected to a stretching force after heating the film to a temperature just below the melt temperature of the polymers in the film. In this manner, the stretching causes the polymer chains to “orient”, changing the physical properties of the film. At the same time, the stretching thins the film. The resulting oriented films are thinner and can have significant changes in mechanical properties such as toughness, heat resistance, stiffness, tear strength, and barrier. Orientation is typically accomplished by an orienting process. A typical blown film coextrusion process does impart some stretching of the film, but not enough to be considered oriented as described herein. An oriented film may be heat set (i.e., annealed) after orientation, such that it is relatively dimensionally stable and has low free shrink under elevated temperature conditions that might be experienced during conversion of the multilayer polyethylene-based film (i.e., printing, laminating).

The multilayer polyethylene-based films may be oriented by any known means that is not limited to single bubble blown film extrusion process or a slot cast sheet extrusion process with subsequent stretching, for example, through a tenter frame process. Machine direction orientation may be accomplished using heated rolls rotating at different speeds and pulling or drawing the film tube in the machine direction. Machine direction orientation levels include a range of from 2× to 8×, and more specifically, in a range of from 4× to 6×. In addition to orientation, the multilayer polyethylene-based film should be annealed such that the film has a free shrink value of less than 20% in both a machine direction and a transverse direction when tested according to ASTM D2732 using a bath temperature of 90° C. The multilayer film may have a free shrink less than 19%, less than 18%, less than 17%, less than 16%, less than 15%, less than 14%, less than 13%, less than 12%, less than 11%, less than 10%, less than 9%, less than 8%, less than 7%, less than 6%, less than 5%, less than 4%, less than 3%, less than 2% or less than 1% in both the machine direction and the transverse direction when tested according to ASTM D2732 using a bath temperature of 90° C. In some embodiments, the multilayer film may have a free shrink of 10% or less in both the machine direction and the transverse direction.

The degree of orientation imparted on a polymeric and transparent film can be measured using the following test method. A light box (e.g., Porta Trace Light Box from Gagne, Inc.) is set up with a light polarizing film on the surface. This first polarizing film is mounted with the polarization direction oriented 45 degrees from the side edge of the light box. A second polarized film should be mounted 10.16 cm 25.4 cm (4 inches to 10 inches) above the first polarizing film with the polarization direction oriented 90 degrees from the polarization direction of the first polarizing film. The sample of the film to be tested should be placed between the polarizing films with the machine direction of the film aligned with the side of the light box. The color of the film can be determined by viewing the sample through the second polarizing film after the light box has been turned on. The degree of orientation can be assessed by the visible colors. Films with little or no orientation appear to be black, gray, or white (or likely a mix of these colors). As orientation increases, other colors appear, starting with, yellow and advancing through orange, blue, and purple. Often the colors are mixed or vary.

The multilayer polyethylene-based film includes a polyethylene-based polymer content in a range of from 90% to 100%, by weight of the multilayer polyethylene-based film. The polyethylene-based polymer content includes the amount of high density polyethylene and additional polyethylene in the multilayer polyethylene-based film. In other words, the “total composition” of the multilayer polyethylene-based film refers to all materials encompassed therein. The total composition of the multilayer polyethylene-based film may include greater than or equal to 90%, greater than or equal to 95%, or greater than or equal to 99%, by weight of polyethylene-based polymer. The total composition of the multilayer polyethylene-based film may include less than or equal to 100%, less than or equal to 95%, or no less than or equal to 90% of polyethylene-based polymer, by weight of multilayer polyethylene-based film.

As used throughout this application, the term “polyethylene” or “PE” refers to, unless indicated otherwise, ethylene homopolymers or copolymers. Polyethylene (e.g., polyethylene-based polymer) is a category of polymer that can be considered a single polymer type. Such copolymers of ethylene include copolymers of ethylene with other units or groups such as vinyl acetate, acid groups, acrylate groups, or otherwise. The term “polyethylene” or “PE” is used without regard to the presence or absence of substituent branch groups. Polyethylene includes, for example, medium density polyethylene (MDPE), high density polyethylene (HDPE), low density polyethylene (LDPE), linear low-density polyethylene (LLDPE), ultra-low density polyethylene (ULDPE), ethylene alpha-olefin copolymer, ethylene vinyl acetate, ethylene acid copolymers, ethylene acrylate copolymers, cyclic olefin copolymers, or blends of such. Various polyethylene polymers may be recycled as reclaimed polyethylene or reclaimed polyolefin.

The multilayer polyethylene-based packaging film includes a high density polyethylene (HDPE) in a range of from 50% to 100%, for example, from 50% to 60%, 60% to 70%, 70% to 80%, 80% to 90%, 90% to 100%, or any range or combination of ranges therein, by weight of the multilayer polyethylene-based film. The total composition of the multilayer polyethylene-based film may include greater than or equal to 50%, greater than or equal to 60%, greater than or equal to 70%, greater than or equal to 80%, or greater than or equal to 90% of high density polyethylene, by weight of polyethylene-based polymer.

As used throughout this application, the term “high density polyethylene” or “HDPE” refers to both (a) homopolymers of ethylene which have densities in a range of from about 0.960 g/cm³ to about 0.970 g/cm³ and (b) copolymers of ethylene and an alpha-olefin (usually 1-butene or 1-hexene) which have densities in a range of from about 0.935 g/cm³ to about 0.960 g/cm³. The high density polyethylene may include a density in a range of from 0.935 g/cm³ to 0.970 g/cm³. High density polyethylene includes polymers made with Ziegler or Phillips type catalysts and polymers made with single site metallocene catalysts. The high density polyethylene may be bimodal and may be pre-nucleated. It is believed that bimodal and pre-nucleated high density polyethylene polymers improve the tear and barrier properties of multilayer polyethylene-based films. The high density polyethylene may include a melt index (MI) in a range of from 0.45 to 2.5 when measured according to ASTM D1238-10. The high density polyethylene may be a single high density polyethylene polymer or a blend of differing high density polyethylene polymers.

The additional polyethylene in the multilayer polyethylene-based film may include non-limiting examples such as a linear low density polyethylene (LLDPE), a low density polyethylene (LDPE), a medium density polyethylene (MDPE), or combinations thereof. The term, “linear low density polyethylene” (LLDPE) includes copolymers of ethylene with alpha-olefins having densities in a range of from 0.915 g/cm³ to 0.940 g/cm³. A LLDPE produced with a metallocene or constrained geometry catalyst is often referred to as “mLLDPE”. Another grouping of polyethylene, “low density polyethylene” (LDPE), is used to denominate branched homopolymers having densities in a range of from 0.915 g/cm³ and 0.930 g/cm³. As used throughout this application, the term “medium-density polyethylene” (MDPE) refers to homopolymers and copolymers of ethylene having a density in a range of from about 0.926 g/cm³ to about 0.940 g/cm^{3.}

The multilayer polyethylene-based film includes a first outer layer that includes a first outer surface of the multilayer polyethylene-based film and a second outer layer that includes a second outer surface of the multilayer polyethylene-based film. The first outer layer and the second outer layer may be exterior layers of the multilayer polyethylene-based film. One of the outer layers may form an inner surface of a package formed from a recyclable packaging film that includes the multilayer polyethylene-based film. Reference to an “inner surface”, as used herein, refers to the surface of a layer or film away from the outermost surface that is towards the interior of a package, for example, adjacent or touching a product contained in the package.

Reference to the terms “outer surface”, “outer layer”, or “outer film”, as used herein, refer to the portion of a film that is located outermost of all the surfaces, layers, regions, or films respectively of the film.

The first outer layer includes a range of from 20% to 100% of polyethylene-based polymer. For example, the first outer layer may include polyethylene-based polymer content in a range of from 20% to 30%, 30% to 40%, 40% to 50%, 50% to 60%, 60% to 70%, 70% to 80%, 80% to 90%, 90% to 100%, or any range or combination of ranges therein, by weight of the first outer layer. In some embodiments, the first outer layer includes polyethylene-based polymer that is known to be more heat resistant than other polyethylene-based polymer, such as high density polyethylene or medium density polyethylene. In an embodiment, the first outer layer includes high density polyethylene in a range of from 20% to 100%, by weight of the first outer layer. For example, the first outer layer may include high density polyethylene in a range of from 20% to 30%, 30% to 40%, 40% to 50%, 50% to 60%, 60% to 70%, 70% to 80%, 80% to 90%, 90% to 100%, or any range or combination of ranges therein, by weight of the first outer layer. In another embodiment, the first outer layer includes medium density polyethylene in a range of from 20% to 100%, by weight of the first outer layer.

The second outer layer includes polyethylene-based polymer content in a range of from 20% to 100%, by weight of the second outer layer. For example, the second outer layer may include polyethylene-based polymer in a range of from 20% to 30%, 30% to 40%, 40% to 50%, 50% to 60%, 60% to 70%, 70% to 80%, 80% to 90%, 90% to 100%, or any range or combination of ranges therein, by weight of the second outer layer. In an embodiment, the second outer layer includes high density polyethylene in a range of from 20% to 100%, by weight of the second outer layer. For example, the second outer layer may include high density polyethylene in a range of from 20% to 30%, 30% to 40%, 40% to 50%, 50% to 60%, 60% to 70%, 70% to 80%, 80% to 90%, 90% to 100%, or any range or combination of ranges therein, by weight of the second outer layer.

The multilayer polyethylene-based film may include a first inner layer and may further include multiple inner layers (i.e., second inner layer, third inner layer, etc.). The first inner layer of the multilayer polyethylene-based film is positioned between the first outer layer and the second outer layer.

The first inner layer or any additional inner layers may include a barrier material. The term “barrier material”, as used herein, refers to a material that significantly reduces the transmission of one or more molecular species through the layer. A barrier material may limit or reduce the permeation of migratory species such as moisture, oxygen, and/or other gasses. Barrier materials typically include metals or polymers and may be a film layer or a coating. Barrier polymeric materials are not limited to polymers including ethylene vinyl alcohol copolymer (EVOH), PVDC, high density polyethylene (HDPE), cyclic olefin copolymers (COC), polyamides, polyacrylates, and polypropylenes. Useful barrier metallic materials may include aluminum or polymeric films coated with metal oxides. In embodiments that include multiple inner layers, the multilayer polyethylene-based film may include multiple layers that include barrier material. The film may include one, two, three, four, or more separate layers comprising barrier materials. The layer including barrier material may be accompanied by other minor components such as slip, antiblock, processing aid, nucleation additives, or hydrocarbon additives. In some embodiments, the multilayer polyethylene-based film may include more than one layer that includes barrier material where each layer includes a barrier material that is different from at least one of the other layers.

In some embodiments, the barrier material may provide oxygen barrier. An oxygen barrier material includes an ethylene vinyl alcohol copolymer. The terms “ethylene vinyl alcohol copolymer” or “EVOH”, as used herein, refer to copolymers comprised of repeating units of ethylene and vinyl alcohol. Ethylene vinyl alcohol copolymers can be represented by the general formula: [(CH₂—CH₂)ₘ—(CH₂—CH(OH))ₙ]. Preferably, ethylene vinyl alcohol copolymers comprise from about 25 mole percent to about 48 mole percent ethylene. EVOH is known to reduce the permeation of oxygen and other gasses through polymeric based packaging films. EVOH includes a density in a range of from 1.12 g/cm³ to 1.24 g/cm³.

The barrier material may provide moisture barrier. Some embodiments of the first inner layer (or any additional inner layer) may include high density polyethylene (HDPE) for moisture barrier improvements. The high density polyethylene of the barrier material may be any of the high density polyethylene polymers previously described that may be used for the first outer layer and the second outer layer.

Some embodiments of the first inner layer (or any additional inner layer) may include polypropylene (PP) for moisture barrier improvements. As used throughout this application, the term “polypropylene” or “PP” refers to a homopolymer or copolymer having at least one propylene monomer linkage within the repeating backbone of the polymer. The propylene linkage can be represented by the general formula: —CH₂—CH(CH₃)—.

Any of the inner layers (e.g., first inner layer, second inner layer, etc.) may include an adhesive layer or tie layer. The terms, “adhesive layer” or “tie layer”, refer to a layer or material placed on one or more layers to promote the adhesion of that layer to another surface. For example, tie layers may be positioned between two layers of a multilayer film to maintain the two layers in position relative to each other and prevent undesirable delamination. In another example, adhesive layers may be positioned between two films of a laminate to maintain the two layers in position relative to each other and prevent undesirable delamination.

Further, any inner layer (e.g., first inner layer, second inner layer, etc.) may include the additional polyethylene. The first inner layer and any additional inner layers are not limited to any particular structure other than contributing to the polyethylene-based polymer content of the multilayer polyethylene-based film being in a range of from 90% to 100%, by weight, where the polyethylene-based polymer content includes the high density polyethylene (HDPE) and the additional polyethylene of the multilayer polyethylene-based film. That is, the amount of the high density polyethylene (HDPE) and the additional polyethylene present in the multilayer polyethylene-based film may be present in the first outer layer, the second outer layer, any inner layer (e.g., first inner layer, second inner layer, etc.), or combinations thereof.

The multilayer polyethylene-based film may include a film thickness in a range of from 12.7 microns (0.5 mil) to 101.6 microns (4.0 mil), 15.2 microns (0.6 mil) to 76.2 microns (3.0 mil), 25.4 microns (1.0 mil) to 50.8 microns (2.0 mil), or any range or combination of ranges therein. The first outer layer may include a first outer layer thickness in a range of from 5% to 30% of the multilayer polyethylene-based film thickness. The second outer layer may include a second outer layer thickness in a range of from 5% to 30% of the multilayer polyethylene-based film thickness. For example, the first outer layer thickness and the second outer layer thickness may include from 10% to 60% of the multilayer polyethylene-based film thickness. Accordingly the first inner layer or the summation of multiple inner layers may include an inner layer thickness in a range of from 40% to 90% of the multilayer polyethylene-based film thickness.

The multilayer polyethylene-based film may include a pigment. The pigment may be present within the first outer layer, the second outer layer, the first inner layer, or any additional inner layers. Pigment is often included in the structure to produce colored film or films that require light blocking.

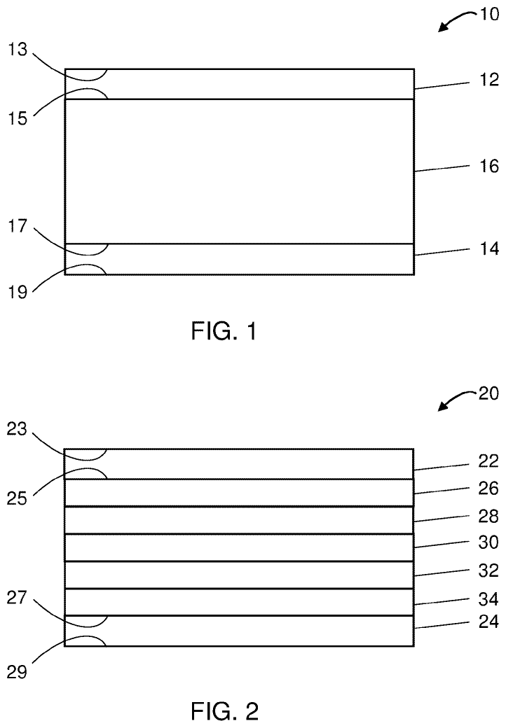

Embodiments of multilayer polyethylene-based films are shown in FIGS. 1-2. A multilayer polyethylene-based film 10 includes a first outer layer 12, a second outer layer 14, and a first inner layer 16. The first outer layer 12 includes a first outer layer first surface 13 and a first outer layer second surface 15. The first outer layer first surface 13 includes a first outer surface of the multilayer polyethylene-based film 10. The first outer layer second surface may be in direct contact with a surface of the first inner layer. The first outer layer second surface 15 is in direct contact with an adjacent surface of the first inner layer 16 as shown in multilayer polyethylene-based film 10. The second outer layer 14 includes a second outer layer first surface 17 and a second outer layer second surface 19. The second outer layer second surface 19 includes a second outer surface of the multilayer polyethylene-based film 10 that opposes the first outer layer first surface 13. The second outer layer second surface may be in direct contact with the first inner layer. The second outer layer second surface 19 is in direct contact with an adjacent surface of the first inner layer 16 as shown in multilayer polyethylene-based film 10.

Another embodiment of a multilayer polyethylene-based film 20 is shown in FIG. 2. The multilayer polyethylene-based film 20 includes a first outer layer 22, a second outer layer 24, a first inner layer 26, a second inner layer 28, a third inner layer 30, a fourth inner layer 32, and a fifth inner layer 34. The first outer layer 22 includes a first outer layer first surface 23 and a first outer layer second surface 25. The first outer layer first surface 23 includes a first outer surface of the multilayer polyethylene-based film 20. The first outer layer second surface 25 is in direct contact with an adjacent surface of the first inner layer 26. The second outer layer 24 includes a second outer layer first surface 27 and a second outer layer second surface 29. The second outer layer second surface 29 includes a second outer surface of the multilayer polyethylene-based film 20 that opposes the first outer layer first surface 23. The second outer layer first surface 27 is in direct contact with an adjacent surface of the fifth inner layer 34. Any of the first inner layer 26, the second inner layer 28, the third inner layer 30, the fourth inner layer 32, or the fifth inner layer 34, may barrier material.

In any embodiment, the multilayer polyethylene-based film may include a first inner layer and may further include any additional number of inner layers. In any embodiment, the first outer layer may be in direct contact with a first inner layer. In any embodiment, the multilayer polyethylene-based film includes a polyethylene-based polymer content that includes a high density polyethylene and an additional polyethylene in an amount that ranges from 90% to 100%, by weight of the multilayer polyethylene-based film. In some embodiments, the multilayer polyethylene-based film includes the high density polyethylene in an amount that ranges from 50% to 100%, by weight of the multilayer polyethylene-based film. In any embodiment, each of the first outer layer or the second outer layer may include a high density polyethylene in an amount that ranges from 20% to 100%, by weight of the multilayer polyethylene-based film.

### Recyclable Packaging Film and Package

A recyclable packaging film includes the multilayer polyethylene-based film described herein. The recyclable packaging film further includes a release over lacquer layer, an ink layer, and a patterned sealable material layer. The recyclable packaging film may include a barrier layer. The recyclable packaging film may be recyclable in some recycling process streams.

The recyclable packaging film may be used in flow wrap package format applications for confectionary products, for example, chocolate-based products, candy, ice cream, etc. Some products are heat sensitive such that the quality of the products may deteriorate with exposure to high heat. For example, chocolate-based products may experience “fat bloom” where the fat that was initially dispersed in the chocolate melts, moves through the chocolate, and crystallizes on the chocolate surface as the chocolate cools. The crystallized fat on the chocolate surface appears as flecks or a coating that is white- or gray-colored. While the coating or flecks of crystallized fat are harmless, they can be unsightly and demonstrate that the chocolate has experienced temperature changes. For at least this reason, heat sealing of film to make packages for confections is typically avoided. For some applications where a temperature gradient does not negatively affect the product contained in the package, a heat seal may be desired. Accordingly, the recyclable packaging film includes a patterned sealable material layer that may include a cold seal material or a heat seal material such as an adhesive or coating. The cold seal material is additionally advantageous for ease of opening a package formed from the recyclable packaging film.

As defined herein, the term “cold seal” refers to the union of a surface (or portion thereof) of one film to a surface (or portion thereof) of another film or of two different portions of a surface of the same film by means of a cold seal material (e.g., pressure sensitive adhesive or material) that can be bonded together by application of pressure and generally at a temperature of less than about 65° C. (150° F.). Cold seal materials include an established class of adhesives characterized by being coated onto substrates to form layers that have the capability of strongly bonding to themselves when pressure is applied, but lacking adhesion to low energy surfaces, e.g., plastic films, coated papers, etc. Cold seal materials are based on mixtures of natural and/or synthetic rubber and are well known in the art. These mixtures can be water and/or solvent based rubber compositions. Cold seal materials may include blends that include acrylates and/or tackifiers. Nonlimiting examples of suitable cold seal material (e.g., cold seal coating, cold seal adhesive coating, etc.) include water-based emulsions, water-based natural rubber latex, natural or synthetic polyisoprene latex, or styrene-butadiene copolymer latex.

As defined herein, the terms “heat seal”, “heat sealable”, or “heat sealed” refer to the union of a surface (or portion thereof) of one film to a surface (or portion thereof) of another film or of two different portions of a surface of the same film by means that can be bonded together by application of both heat and pressure. Heat sealing is a well-known and commonly used process for creating packages and is familiar to those skilled in the art. During heat sealing, the patterned sealable material layer that includes heat seal material softens due to the application of heat, allowing formation of a heat seal bond. It may be advantageous if the heat seal material softens and seals at a relatively low seal initiation temperature (SIT) to enable faster packaging line speeds and reduced risk of product damage. Lower seal initiation temperature (SIT) enables faster packaging line speeds. For example, some embodiments may include a heat seal material that exhibits an SIT of less than or equal to 110° Celsius (° C.), (230° Fahrenheit (° F.)), less than or equal to 100° C. (212 (230° F.), or less than or equal to 90° C. (194° F.). Nonlimiting examples of suitable heat seal material (e.g., heat seal coating, heat seal adhesive coating, etc.) include acrylate copolymers, PET, PE, PP, or hot melts (wax based).

In an embodiment, the patterned sealable material layer may include heat seal material or cold seal material and may be applied to the second outer surface of the multilayer polyethylene-based film (i.e., the second outer layer second surface that may be in contact with a product contained in a package formed from the recyclable packaging film). The patterned sealable material layer may be applied in a pattern that corresponds with the seals or sealed areas of a package formed from the recyclable packaging film. The patterned sealable layer is applied by standard printing methods known in the art, including flexographic and rotogravure printing techniques. The patterned sealable material may have a basis weight in a range of from 1 g/m² and 10 g/m². The patterned sealable material may have a basis weight in a range of from 2 g/m² and 6 g/m². The patterned sealable material layer may form a hermetic seal in a package formed from the recyclable packaging film.

The recyclable packaging film may further include an ink layer positioned on the first outer surface of the multilayer polyethylene-based film (i.e., the first outer layer first surface that opposes the second outer surface that includes the patterned sealable material layer). The ink layer may be continuous or discontinuous (e.g., patterned). The recyclable packaging film may include multiple ink layers. The ink layer may include graphics, pertinent regulatory or marketing information, for example.

The recyclable packaging film includes a release over lacquer layer adjacent to the first outer surface of the multilayer polyethylene-based film. The release over lacquer layer may be in direct contact with the ink layer. The release over lacquer layer may be in direct contact with portions of the first outer surface of the multilayer polyethylene-based film that do not include ink (e.g., a discontinuous ink layer). The release over lacquer layer may include lacquers also referred to as varnishes, overprints, overprint varnish, etc. Non-limiting release over lacquers may include polyamide-based or nitrocellulose-based release over lacquers. The first outer surface of the multilayer polyethylene-based film must repel adhesion (i.e., roll blocking) to and provide sufficient release from the patterned sealable material layer so that roll stock of the recyclable packaging film may be unwound during package conversion. The release over lacquer layer may further protect the ink layer from flaking off or scuffing when exposed to the rigors of packaging lines, shipping stresses, or consumer misuse. The release over lacquer layer may be printed or extruded by means known in the art, onto the first outer surface of the multilayer polyethylene-based film that opposes the second outer surface that includes the patterned sealable material layer. The release over lacquer layer is applied in a manner such that the addition to the total thickness of the recyclable packaging film is negligible. For example, coat weights for the release over lacquer layer may be from 0.6 lb/ream (lb/ream) to 1 pound per ream, or any range or combination of ranges therein. In some embodiments, the release over lacquer layer includes a polyamide matrix with one or more wax additives. In some embodiments, the release over lacquer layer may include a water-based release lacquer material that is believed to be advantageous for the release of coatings and inks from the non-seal side of the structure. In some embodiments, the release over lacquer layer is coextensive with the first outer surface of the multilayer polyethylene-based film.

The recyclable packaging film may include a barrier layer. The barrier layer may include a coating or film. The barrier layer may include ethylene vinyl alcohol copolymer (EVOH), polyvinyl alcohol copolymer (PVOH), butenediol vinyl alcohol copolymer (BVOH), crosslinked acrylates, or partially neutralized acrylic polymers, for example. The barrier layer may include copolymers of monobasic ethylenically unsaturated carboxylic acids with ethylene, such as ethylene acrylic acid (EAA) or ethylene methacrylic acid (EMAA) that may be partially neutralized with metal salts, for example, sodium or zinc. Water dispersible acidic moieties may further include polyacrylic acids (PAA) such as ionically or covalently crosslinked polycarboxylates, polymethacrylates such as polymethacrylic acid (PMAA), mixtures of polyacrylic acid and polymethacrylic acid, and partially or fully neutralized forms thereof. In an embodiment, the water dispersible material including acidic moieties may include EAA, EMAA, PAA, PMAA, or combinations thereof. Suitable water dispersible acidic moieties, such as PAA, include those available under the trade name of ACUMER developed by Dow. One or a combination of barrier materials may be used in individual or multiple barrier layers.

Barrier layers are typically thin and may be pattern-applied. The barrier layer may be positioned, for example, i) between the ink layer and the release over lacquer layer, ii) between the first outer surface of the multilayer polyethylene-based film (i.e., the first outer layer first surface) and the ink layer, or iii) on an outer surface of the release over lacquer layer. In some embodiments, a primer layer may be present between any of the layer combinations, i)-iii), for example.

Many different types of barrier layer materials can be used without hindering the recyclability of the film due to the small amount of barrier material present. Thin layers of depositions or coatings may be useful for the recyclable films as the amount of material used can be easily incorporated into the recycling stream without the need for compatibilizers.

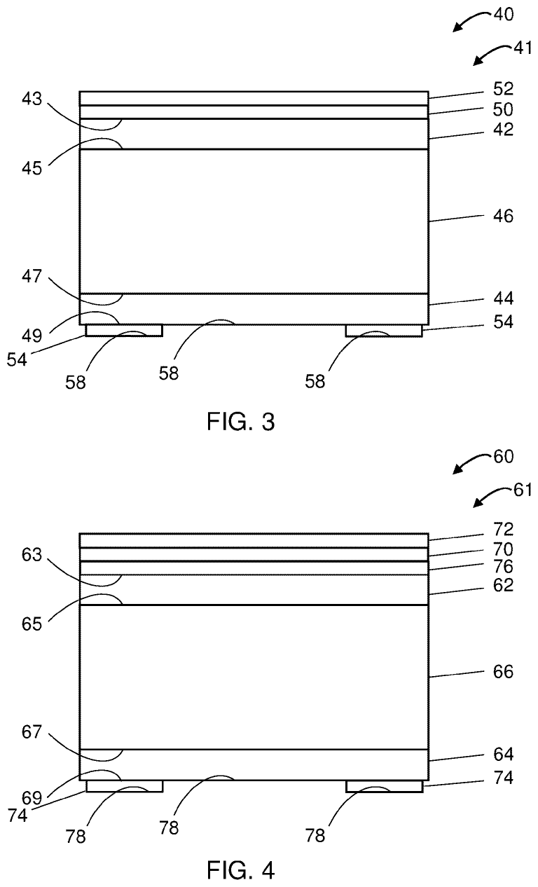

With reference to FIG. 3, an embodiment of a recyclable packaging film is shown. A recyclable packaging film 40 includes a multilayer polyethylene-based film 41. The multilayer polyethylene-based film 41 includes a first outer layer 42, a second outer layer 44, and a first inner layer 46. The first outer layer 42 includes a first outer layer first surface 43 and a first outer layer second surface 45. The first outer layer first surface 43 includes a first outer surface of the multilayer polyethylene-based film 41. The second outer layer 44 includes a second outer layer first surface 47 and a second outer layer second surface 49. The second outer layer second surface 49 includes a second outer surface of the multilayer polyethylene-based film 41 that opposes the first outer layer first surface 43. The recyclable packaging film 40 includes an ink layer 50 that includes the first outer layer first surface 43. In some embodiments, the ink layer may be positioned directly adjacent to or on the first outer layer first surface. In some embodiments, the ink layer may be positioned indirectly adjacent to the first outer layer first surface.

The recyclable packaging film 40 includes a release over lacquer layer 52 positioned on an outer surface of the ink layer 50. The release over lacquer layer may include a first exterior surface of the recyclable packaging film. In any embodiment, the ink layer is positioned between the first outer layer first surface that includes the first outer surface of the multilayer polyethylene-based film and the release over lacquer layer. The recyclable packaging film 40 includes a patterned sealable material layer 54 that is shown in a discontinuous pattern and includes the second outer layer second surface 49. An interior surface 58 of the recyclable packaging film 40 is formed by both the second outer layer 44 and the patterned sealable material layer 54 that is shown to be patterned, and may include a second exterior surface of the recyclable packaging film. In the regions of the patterned sealable material layer 54, the interior surface 58 is sealable material and the interior surface 58 is polymeric film in other regions.

In other embodiments, the recyclable packaging film may include multiple inner layers. Any of the inner layers may include a barrier layer including barrier material or tie or adhesive layers.

Another embodiment of a recyclable packaging film 60 is shown in FIG. 4. The recyclable packaging film 60 includes a multilayer polyethylene-based film 61. The multilayer polyethylene-based film 61 includes a first outer layer 62, a second outer layer 64, and a first inner layer 66. The first outer layer 62 includes a first outer layer first surface 63 and a first outer layer second surface 65. The first outer layer first surface 63 includes a first outer surface of the multilayer polyethylene-based film 61. The second outer layer 64 includes a second outer layer first surface 67 and a second outer layer second surface 69. The second outer layer second surface 69 includes a second outer surface of the multilayer polyethylene-based film 61 that opposes the first outer layer first surface 63. The recyclable packaging film 60 includes a barrier layer 76 that includes the first outer layer first surface 63. The recyclable packaging film 60 includes an ink layer 70 that includes an outer surface of the barrier layer 76. In some embodiments, the barrier layer may be positioned directly on the first outer layer first surface. The recyclable packaging film 60 include a release over lacquer layer 72 positioned on an outer surface of the ink layer 70. The release over lacquer layer may include a first exterior surface of the recyclable packaging film. In any embodiment, the ink layer is positioned between the first outer layer first surface that includes the first outer surface of the multilayer polyethylene-based film and the release over lacquer layer. The recyclable packaging film 60 includes a patterned sealable material layer 74 that is shown in a discontinuous pattern and includes the second outer layer first surface 69. An interior surface 78 of the recyclable packaging film 60 is formed by both the second outer layer 74 and the patterned sealable material layer 74, and may include a second exterior surface of the recyclable packaging film. In the regions of the patterned sealable material layer 74, the interior surface 78 is sealable material and the interior surface 78 is polymeric film in the other regions. In other embodiments, the recyclable packaging film may include multiple inner layers. Any of the inner layers may include a barrier material or tie or adhesive layers.

A packaging film may have a similar structure to the multilayer polyethylene-based film described herein. In some embodiments, the packaging film may include an appropriate polyethylene polymer content that the packaging film may be acceptable in a recycling stream or process (i.e., the packaging film may be a recyclable packaging film). The packaging film includes a multilayer polyethylene-based film. The multilayer polyethylene-based film includes a first outer surface and a second outer surface. A release over lacquer layer may be adjacent to the first outer surface. The release over lacquer layer may be directly adjacent to the first outer surface. An ink layer may be positioned between the first outer surface and the release over lacquer layer. A patterned sealing material layer may be positioned on the second outer surface and may include a cold seal material or a heat seal material. The multilayer polyethylene-based film may include a high density polyethylene in a range of from 50% to 100%, for example of from 50% to 60%, 60% to 70%, 70% to 80%, 80% to 90%, 90% to 100%, or any range or combination of ranges therein, by weight of the multilayer polyethylene-based film. The multilayer polyethylene-based film may include a low density polyethylene and/or a linear low density polyethylene in a range of from 0% to 50%, for example, 0% to 10%, 10% to 20%, 20% to 30%, 30% to 40%, 40% to 50%, or any range or combination of ranges therein, by weight, of the multilayer polyethylene-based film. The multilayer polyethylene-based film may include a medium density polyethylene in a range of from 0% to 40%, for example, 0% to 10%, 10% to 20%, 20% to 30%, 30% to 40%, or any range or combination of ranges therein, by weight of the multilayer polyethylene-based film. In some embodiments, the packaging film may include a polyethylene-based polymer content in a range of from 90% to 100%, for example, 90% to 95%, 95% to 100%, or any range or combination of ranges therein, by weight of the packaging film. The packaging film may further include a density of less than 1.0 g/cm³ and greater than 0.0 g/cm³. The packaging film may include barrier and physical properties similar to the recyclable packaging film.

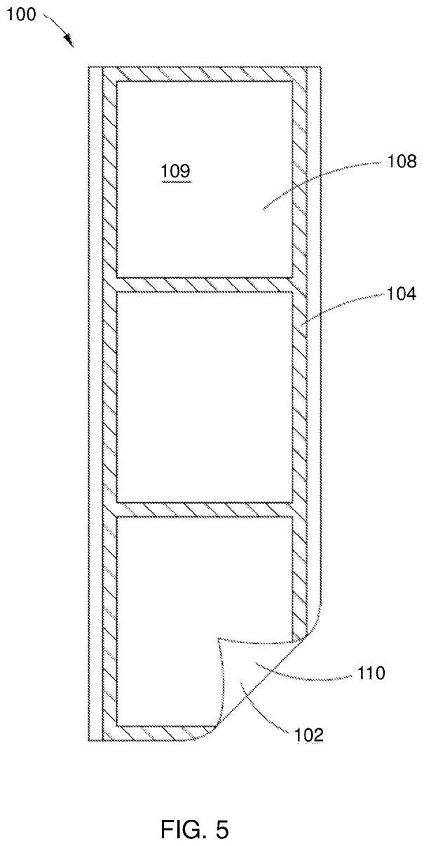

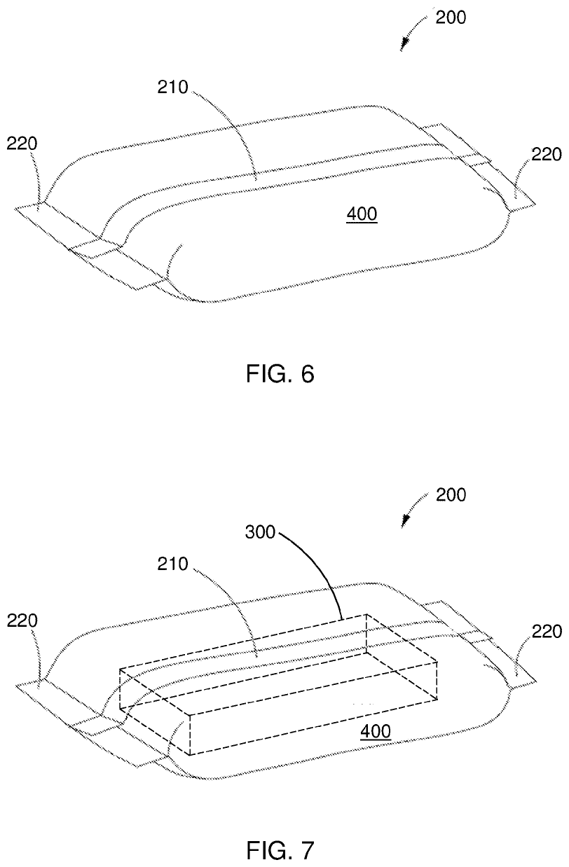

FIG. 5 shows a plan view of an interior surface 108 of an embodiment of a recyclable packaging film 100 which may be useful for producing a flow-wrap style package, such as a package 200 shown in FIG. 6. In some embodiments, an interior surface 108 includes a patterned sealable material layer 104 in the regions in which the patterned sealable material layer 104 is patterned (pattern of application shown in hash-marked area). The interior surface 108 also includes the second outer surface 109 of the multilayer polyethylene-base film in the regions not covered by the patterned sealable material layer 104. The interior surface may correspond with a second exterior surface of a recyclable packaging film. The bottom corner of the recyclable packaging film 100 is turned up to expose the release over lacquer layer 102 on a first outer surface 110 of the recyclable packaging film 100. The first outer surface may correspond with a first exterior surface of a recyclable packaging film.

The recyclable packaging film or the packaging film may be formed into a variety of packages that result from conversion of the recyclable packaging film with the use of flow wrap packaging machinery (i.e., horizontal form fill seal (HFFS) or vertical form fill seal (VFFS)). The recyclable packaging film or the packaging film may also be converted on non-form fill seal packaging machinery and may be formed into package formats that include sachets, pillow packs, and pouches, for example.

FIGS. 6-7 show perspective views of a sealed flow wrap package 200, formed from a recyclable packaging film 400. The recyclable packaging film 400 may have the same properties of the recyclable packaging films 40, 60, 100 shown in FIGS. 3-5. In some embodiments, a package may be formed from the packaging film. The recyclable packaging film 400 has been converted through a flow wrap style packaging machine, sealing the film 400 around a product 300. FIG. 7 shows the product 300 packaged in the package 200. The recyclable packaging film 400 is oriented such that a first exterior surface of the recyclable packaging film 400 (i.e., surface including the release over lacquer layer) is on the outside of the package 200. The first exterior surface may be viewed by a consumer. A second exterior surface of the recyclable packaging film 400 (i.e., the surface closest to product 300 that includes polymeric film and patterned sealable material) forms an internal surface on the interior of the package 200. The patterned sealable material is connected to itself for sealing the package 200. The package 200 may be hermetically sealed. The package 200 includes a fin seal 210 along the length of the package 200 and two end seals 220 that are generally perpendicular to the fin seal 210.

The recyclable packaging film may include properties that facilitate easy consumer use. For example, the recyclable packaging film may include Elmendorf Tear values in the machine direction or in the transverse direction in a range of from 1 g/25.4 mm to 250 g/25.4 mm using ASTM D1922-09 when tested with a 200 gram pendulum. Elmendorf Tear values from 1 g/25.4 mm to 150 g/25.4 mm in a machine direction may be indicative of film that includes low tear resistance and accordingly, a package formed from the recyclable packaging film includes ease of tear or ease of opening when being torn open.

The recyclable packaging film may provide product protection through barrier to oxygen and moisture vapor transmission. The recyclable packaging film, which includes the multilayer polyethylene-based film and a release over lacquer layer, may include a normalized oxygen transmission rate (OTR) from 1,000 cubic centimeters/meter²/day/mil (cc/m²/day/mil) or less, when measured at 22.78° C. (73° F.) and 0% relative humidity (RH) according to ASTM F1927-07. The normalized OTR accounts for the thickness of the film that was sampled (i.e., measured OTR*film thickness value=normalized OTR value). The recyclable packaging film may include a normalized moisture vapor transmission rate (MVTR) from 2.0 grams/meter²/day/mil (g/m²/day/mil) or less, when measured at 37.78° C. (100° F.) and 90% relative humidity according to ASTM F1249-06. The normalized MVTR accounts for the thickness of the film that was sampled (i.e., measured MVTR*film thickness value=normalized MVTR value).

The recyclable packaging film includes a film density of less than 1.0 gram/cubic centimeter (g/cc). Recyclable packaging films that include a density of less than 1 g/cc may be recyclable in many recycling process streams.

The unique combination of tensile properties and stiffness of the recyclable packaging film may be critical to successful converting of the film on packaging converting machinery to form a package. It was surprisingly discovered that the recyclable packaging film is conversion friendly, although the tensile properties and stiffness differ from non-recyclable packaging films. Films that include large amounts of high density polyethylene typically do not include appropriate stiffness or other physical properties to convert well on package converting machinery as known by one of skill in the art. A lack of film stiffness and/or too much film stretch can cause poor registration. The recyclable packaging film was found to run on a flowwrap machine for packaging confectionary at the same speeds as conventional confectionary packaging film. The recyclable packaging film additionally cuts cleanly. Advantageously, the recyclable packaging film can be readily adopted into current packaging applications without sacrificing process efficiencies. Stiffness of the recyclable film can be measured by a loop stiffness test. The recyclable packaging film includes a loop stiffness value in each of the machine direction or in the transverse direction in a range of from 20 grams-force (gf) to 35 grams-force (gf) or less when tested according to a loop stiffness test method described herein.

### Examples

Multilayer polyethylene-based film Examples 1 and 2 were constructed as seven layer coextruded blown films having layers as described in TABLE 1. Examples 1 and 2 differed only in the selection of high density polyethylene used in each example. Each layer included approximately 1% to 2% processing aids. Example 1 and 2 film structures resembled the polyethylene-based film illustrated in FIG. 2 and included a total thickness in a range of from 64.5 microns to 70.6 microns (2.54 mils to 2.78 mils).

TABLE 1

| | Layer thickness | | |
|---|---|---|---|
| Layer | of total thickness | Example 1 | Example 2 |
| 1 | 15% | MDPE, ~65.5% | MDPE, ~65.5% |
| | | White concentrate | White concentrate |
| | | (70%), ~32.5% | (70%), ~32.5% |
| 2 | 15% | HDPE1, ~100% | HDPE2, ~100% |
| 3 | 15% | HDPE1, ~100% | HDPE2, ~100% |
| 4 | 15% | HDPE1, ~65.5% | HDPE2, ~65.5% |
| | | White concentrate | White concentrate |
| | | (70%), ~32.5% | (70%), ~32.5% |
| 5 | 10% | HDPE1, ~100% | HDPE2, ~100% |
| 6 | 20% | HDPE1, ~100% | HDPE2, ~100% |
| 7 | 10% | HDPE1, ~100% | HDPE2, ~100% |

MDPE = Medium density polyethylene
HDPE1 = High density polyethylene having a density of 0.967 and a melt index of 2.0
HDPE2 = High density polyethylene having a density of 0.966 and a melt index of 1.2

Oxygen and moisture barrier properties of film Examples 1 and 2 are shown in TABLE 2. Oxygen transmission rate (OTR) was measured according to ASTM F1927-07. Moisture transmission rate (MVTR) was measured according to ASTM F1249-06.

TABLE 2

| | OTR @ 22.8 °C, | | MVTR @ 37.8 °C, | |
|---|---|---|---|---|
| | 0% RH Out - 0% RH In | | 90% RH Out | |
| | | Thickness | | Thickness |
| | cc/m²/day | (microns) | g/m²/day | (microns) |
| Example 1 | 281 | 2.66 | 0.57 | 2.68 |
| Example 2 | 306 | 2.69 | 0.66 | 2.55 |

Physical properties of film Examples 1 and 2, and Comparative Example 1 are shown in TABLE 3. Comparative Example 1 was a commercially available polypropylene-based film that can be used in confectionary applications. Comparative Example 1 was a white-pigmented, cavitated, oriented PP film having a total thickness of 30 microns (1.18 mil).

Force at Break, Elongation at Break, and Energy Absorption were measured according to ASTM D882-12. Elmendorf Tear was measured according to ASTM D1922-09 with a 200 g pendulum used with the machine direction (MD) and a 400 g pendulum used with the transverse direction (TD) of the films. Kinetic COF was measured according to ASTM D1894-06. Loop stiffness was measured using an Instron® tensile tester from Instron Corporation, Norwood, MA, U.S.A. having a 1,000 gram load cell. Specimen samples were prepared by cutting a 10.16 cm (4 inch) by 10.16 cm (4 inch) sample of each film and folding opposing ends of the sample towards themselves to form a loop. The folded sample was placed into a specimen holding fixture so that the opposing sides of the sample were separated by a distance of 2.54 cm (1.0 inch). A 0.635 cm (0.25 inch) thick by 12.7 cm (5 inch) long stainless steel test probe was fitted to an Instron® mechanical testing instrument. The instrument was set to the “stiffness” internal protocol. The amount of force required to bend or deflect the sample approximately 1.27 cm (0.5 inch) at the vertex of the loop was measured. The test is run using a crosshead speed of 12.7 cm/minute (5 in/minute) and a stop distance of 1.27 cm (0.5 inch). The film is inserted with a first exterior layer of the material is facing up. MD specimens are mounted with the MD traveling the length of the loop. TD specimens are mounted with MD perpendicular to the length of the loop. The upper crosshead of the tensile testing unit has a flat breaker plate which is lowered to a position just slightly above the sample. The force of the loop against the breaker plate is recorded as the loop stiffness value. Samples were tested at 22.78° C. Five measurements were taken for each film and the average of the results are reported.

TABLE 3

| | | | Comparative |
|---|---|---|---|
| Physical Property | Example 1 | Example 2 | Example 1* |
| Force at Break (lbs), | 11.14/10.68 | 13.68/10.55 | 16.5/28.8 |
| MD/TD | | | |
| Elongation at Break (%), | 860/9 | 856/7 | 131/37 |
| MD/TD | | | |
| Energy Absorption (lb/in), | 66.00/0.83 | 71.73/0.66 | 15.18/7.53 |
| MD/TD | | | |
| Loop Stiffness (g), | 26.3/30.9 | 24.4/31.9 | 3.1/4.8 |
| MD/TD | | | |
| Tear(g), | 47/104 | 44/152 | 5.2/3.8** |
| MD/TD | | | |
| Kinetic COF (out/in to metal) | 0.13/0.10 | 0.14/0.11 | 0.25/0.25 |
| (out/out) | | | |

*Comparative Example 1 thickness was less than that of Examples 1 and 2.
**Comparative Example 1 Tear in the TD was measured with a 400 gram pendulum.

Film Examples 3 and 4 correspond to film Examples 1 and 2, respectively, that were coated with a release over lacquer layer. A release over lacquer suitable for cold seal adhesive, as known by one of skill in the art, was applied onto the MDPE layer of the film structure. Oxygen and moisture barrier properties of film Examples 3 and 4 are shown in TABLE 4. Oxygen transmission rate (OTR) was measured according to ASTM F1927-07. Moisture transmission rate (MVTR) was measured according to ASTM F1249-06. The addition of a release over lacquer layer to the films of Examples 1 and 2 had negligible impact on the oxygen and moisture barrier transmission rates.

TABLE 4

| | OTR @ 22.8 °C, | | MVTR @ 37.8 °C, | |
|---|---|---|---|---|
| | 0% RH Out - 0% RH In | | 90% RH Out | |
| | | Thickness | | Thickness |
| | cc/m²/day | (microns) | g/m²/day | (microns) |
| Example 3 | 258 | 2.73 | 0.59 | 2.69 |
| Example 4 | 316 | 2.67 | 0.64 | 2.62 |

The above description and examples illustrate certain embodiments of the present disclosure and are not to be interpreted as limiting. Selection of particular embodiments, combinations thereof, modifications, and adaptations of the various embodiments, conditions and parameters normally encountered in the art will be apparent to those skilled in the art and are deemed to be within the spirit and scope of the present disclosure.

What is claimed is:

1. A recyclable packaging film comprising:
a multilayer polyethylene-based film comprising a first outer layer comprising a first outer surface of the multilayer polyethylene-based film, and a second outer layer comprising a second outer surface of the multilayer polyethylene-based film;
a release over lacquer layer comprising a first exterior surface of the recyclable packaging film;
an ink layer positioned between the first outer surface of the multilayer polyethylene-based film and the release over lacquer layer; and
a patterned sealable material layer positioned on the second outer surface of the multilayer polyethylene-based film comprising a second exterior surface of the recyclable packaging film;
wherein the multilayer polyethylene-based film comprises a polyethylene-based polymer content comprising a high density polyethylene and an additional polyethylene in a range of from 90% to 100%, by weight of the multilayer polyethylene-based film.

2. The recyclable packaging film of claim 1, wherein the multilayer polyethylene-based film comprises the high density polyethylene in a range of from 50% to 100%, by weight of the multilayer polyethylene-based film.

3. The recyclable packaging film of claim 1, wherein the high density polyethylene has a density in a range of from 0.935 g/cm³ to 0.970 g/cm³.

4. The recyclable packaging film of claim 1, wherein the multilayer polyethylene-based film comprises a free shrink value of less than 20% in both a machine direction and a transverse direction when tested according to ASTM D2732 using a bath temperature of 90° C.

5. The recyclable packaging film of claim 4, wherein the multilayer polyethylene-based film comprises a free shrink value of 10% or less in both a machine direction and a transverse direction when tested according to ASTM D2732 using a bath temperature of 90° C.

6. The recyclable packaging film of claim 1, wherein the additional polyethylene comprises linear low density polyethylene (LLDPE), a low density polyethylene (LDPE), a medium density polyethylene (MDPE), or a combination thereof.

7. The recyclable packaging film of claim 1, wherein the first outer layer comprises the high density polyethylene in a range of from 20% to 100%, by weight of the first outer layer.

8. The recyclable packaging film of claim 1, wherein the second outer layer comprises the high density polyethylene in a range of from 20% to 100%, by weight of the second outer layer.

9. The recyclable packaging film of claim 1, further comprising a barrier layer comprising ethylene vinyl alcohol copolymer (EVOH), polyvinyl alcohol copolymer (PVOH), butenediol vinyl alcohol copolymer (BVOH), crosslinked acrylates, partially neutralized acrylic polymers, copolymers of monobasic ethylenically unsaturated carboxylic acids with ethylene, water dispersible acidic moieties, or combinations thereof.

10. The recyclable packaging film of claim 9, wherein the barrier layer is positioned between the first exterior surface of the recyclable packaging film and the second exterior surface of the recyclable packaging film, on the first exterior surface of the recyclable packaging film, or combinations thereof.

11. The recyclable packaging film of claim 1, wherein the multilayer polyethylene-based film comprises a thickness in a range of from 0.6 mil to 3.0 mil.

12. The recyclable packaging film of claim 1, wherein the multilayer polyethylene-based film comprises a normalized moisture vapor transmission rate lower than 2.0 g/m²/day per mil according to ASTM F1249-06.

13. The recyclable packaging film of claim 1, further comprising a density of less than 1.0 g/cm³.

14. The recyclable packaging film of claim 1, wherein the patterned sealable material layer comprises a cold seal material.

15. The recyclable packaging film of claim 1, further comprising a pigment.

16. A packaging film comprising:
a multilayer polyethylene-based film having a first outer surface and a second outer surface;
a release over lacquer layer adjacent to the first outer surface;
an ink layer positioned between the first outer surface and the release over lacquer layer; and
a patterned sealable material layer positioned on the second outer surface;
wherein the multilayer polyethylene-based film comprises a high density polyethylene in a range of from 50% to 100%, by weight of the multilayer polyethylene-based film, a low density polyethylene and/or a linear low density polyethylene in a range of from 0% to 50%, by weight of the multilayer polyethylene-based film, and a medium density polyethylene in a range of from 0% to 40%, by weight of the multilayer polyethylene-based film.

17. The packaging film of claim 16, further comprising a polyethylene-based polymer content in a range of from 90% to 100%, by weight of the packaging film.

18. The packaging film of claim 16, further comprising a density of less than 1.0 g/cm³.
